(19) United States
(12) Patent Application Publication
(10) Pub. No.: US 2011/0146427 A1
(43) Pub. Date: Jun. 23, 2011

(54) DEVICE FOR CONVERTING OSCILLATORY MOTION INTO UNIDIRECTIONAL ROTATIONAL MOTION

(75) Inventor: Igory Kolokolynikov, Ekaterinburg (RU)

(73) Assignee: MERS, LLC, Yekaterinburg (RU)

(21) Appl. No.: 13/058,980

(22) PCT Filed: Sep. 9, 2009
(86) PCT No.: PCT/RU2009/000461

§ 371 Date: Feb. 14, 2011

(30) Foreign Application Priority Data
Sep. 15, 2008 (RU) 2008137040

(51) Int. Cl. F16H 19/04

(52) U.S. Cl. 74/34

(57) ABSTRACT

The invention relates to mechanical engineering, in particular to devices for converting oscillatory motion into unidirectional rotational motion and can be used, for example, in lifting devices, electric power producing devices, machine tools, pumps and transportation means, particularly internal combustion engines. The device comprises a body and input and output axes. The essence of the invention is that the device is provided with an intermediate axis arranged in the body perpendicularly to the input axis, at least two rotation transmitting coupling elements in the form of a freewheel clutch or ratchet clutch rigidly mounted on the output axis so as to be capable of mutually inverse rotational action and at least three interconnected rotation transmitting elements rigidly mounted between the coupling elements so as to be capable likewise of mutually inverse rotational action for transmitting the rotation of the output axis in one direction. Said invention makes it possible to increase the operational efficiency of the device by converting the rotation of the input axis, which has an unlimited angle of rotation in either direction, into the unidirectional rotation of the output axis at the same rotational velocity and to extend the functionalities of the device.

### FIELD OF MECHANICAL ENGINEERING

The invention is related to mechanical engineering, specifically to mechanisms for converting reciprocating rotary motion into unidirectional rotation motion. The invention can be used, for instance, in lifting devices, electric power generators, machine-tools, pumps, transport facilities, and particularly in internal-combustion engines.

### PRIOR ART

Known devices for converting motion are used, for example, in lifting devices, especially in winches (RU No. 2045469 pb. 10, Oct. 1995, SU No. 929535 pb. 23, Mar. 1982). The main disadvantage of these devices is the idling, which leads to a decrease in the efficiency of applied forces.

A device for converting motion is known (SU No. 812703 pb. 15, Mar. 1981), which contains two separate spools on which a hawser is inversely wound, leading to an increasing of number of components and size of the device.

The closest prior art reference, accepted as a prototype, is a device for converting reciprocating rotary motion, and is comprised of a frame body and input and output axles located on one axle (patent RU No. 2239739, pb. 10, Nov. 2004).

The disadvantage of this device is the rigidly fixed limited angle of rotation of the input axle from one point to another, so that the device is functional only when the input axle is rotated from one point to another by a certain angle. If the device stops at one of these two points, then it will not be able to rotate the input axle to run the device, since the crank buttons will be deadlocked.

When using the device in an internal combustion engine and the engine pulse fails in at least one of the cylinders, the engine will break down because the inert flywheel of the output axle will pull the input axle to rotate in the same direction, instead of the necessary reverse motion. Herewith, the cylinder piston will strike the combustion head.

At the rotation of the input axle from one point to another, the angular speed of the output axle will match the speed of input axle, and during the reverse rotation of the input axle, the angular rate of rotation of the output axle will be nonlinear (that is, at the beginning, it will be slowing and then accelerating relative to the speed of input axle).

When using the specified known device in internal-combustion engines, in which an inertial flywheel is installed on the output axle in order to smooth uneven motions, the unevenness of the angular rates influences the velocities of the elements of the input axle and this, in turn, leads to an unevenness in movement of piston group that will unbalance the engine and cause it to shake.

### INVENTION DISCLOSURE

The task to be solved by this solution is to increase the efficiency of the device by converting the rotation on the input axle with unlimited angle of rotation in either direction into unidirectional rotation of the output axle.

The problem is solved as follows.

The device for converting of reciprocating rotary motion into rotation, that comprises a body frame with input and output axles, according to the invention, includes at least one intermediate axle installed in the body frame perpendicular to the input axle, with at least two rotation transmitting coupling elements in the form of a free-wheel clutch and ratchet clutch rigidly mounted on the output axle with the possibility of mutually opposite rotational action, and at least three interconnected rotation transmitting elements rigidly mounted between the coupling elements so as to also be capable of mutually opposite rotation for transmitting the rotation of the output axle in one direction.

One of the rotation transmitting elements is rigidly installed on the intermediate axle, and two others are rigidly interconnected with coupling elements. The rotation transmitting element is carried out in the form of conical gear. Axles are used as the input, output and intermediate axles.

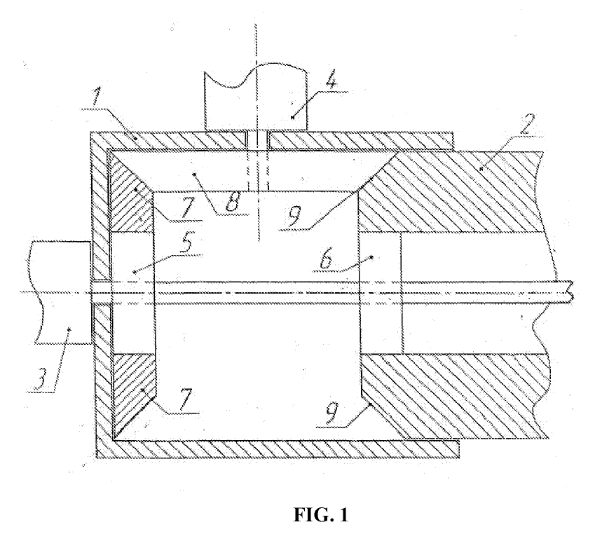

FIG. 1 is the present device, general view, longitudinal section.

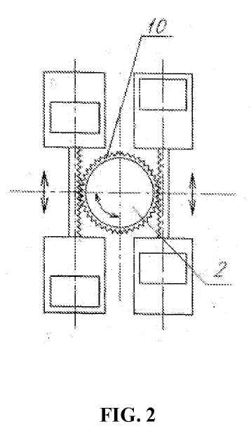

FIG. 2 is an example of the claimed device used in an internal combustion engine.

### Example Embodiment

The device contains stationary frame 1, the walls of which have holes used for the installation of input axle 2, located on the same axis as output axle 3. The device also contains an intermediate axle 4 mounted perpendicularly to an output axle 3. Axles are used as the input, output and intermediate axles.

The device contains at least one input axle 2. Additionally, the device may contain one or two output axles 3. The input 2 and output 3 axles can be mounted on the same common axis or can be installed perpendicular to each other.

On the output axle 3, two coupling elements 5 and 6 are rigidly mounted with the possibility of mutually opposite rotational action for transmitting the rotation in one direction, t ratchets or free-wheel clutches being used as the coupling elements. (Applied mechanics. Study guide for higher education. Ed. by O. E. Oseckiy. Iss. 2, “Mashinostrojenije”, 1977, 458 p.). Input axle 2 is rigidly mounted on coupling element 6, and coupling element 5 is rigidly installed on output axle 3. Input axle 2 rolls around freely in body frame 1. The device also contains the rotation transmitting elements 7, 8, 9. The rotation transmitting element 7 is rigidly mounted on coupling element 5 and forms a rotational pair with rotation transmitting element 8 rigidly mounted on intermediate axle 4. The rotation transmitting element 8, in turn, transmits the rotation to the rotation transmitting element 9, installed on the input axle 2, which is rigidly interconnected with the coupling element 6.

Intermediate axle 4 is used as a free axle for installing a conical rotation transmission element 8.

In this case, the speed of rotation of the output axle 3 is equal to the speed of rotation of the input axle 2 independent of the magnitude of the transmission coefficient of rotation transmitting element 8.

A variant of the active use of the intermediate axle 4 as an input axle is possible. In this case, depending on the size of the diameter of the rotation transmitting element 8, which affects the transmission coefficient, the angular speed rate of output axle 3 will change relative to the intermediate axle 4.

Device operates as follows.

Input axle 2, rigidly planted on the coupling element 6, rotates clockwise and passes the rotation through the coupling element 6 to the output axle 3. At that, the rotation is transmitted via conical rotation transmitting elements 7, 8, 9 to the coupling element 5 in the reverse direction of the rotation of axle 2, causing it to slip freely in coupling element 5 relative to the output axle 3, without causing it to change the direction of rotation.

When the input axle 2 rotates in the other direction (counterclockwise), the coupling element 6 starts the free sliding relative to the output axle 3, and the rotational movement is transmitted via pairs of rotation transmission elements 7, 8, 9 to the coupling element 5, which engages with the output axle 3. Thus, the output axle 3 rotates in the same direction as during the previous cycle, that is clockwise.

The input axles 2 and 4 have common properties allowing reciprocating rotary motion to be passed onto the output axle 3 in order to obtain its rotation in one direction.

Due to the construction of the device, the output axle 3 is able to rotate freely in a given direction regardless of the direction of rotation of the input axles 2, 4, even if they are immovable. When using the element accumulating the energy of rotation—the flywheel mounted on the output axle 3, the input axles 2 and 4 will transmit the rotation to the output axle 3 only when their speed is greater than or equal to the speed of rotation of the output axle 3.

The output axle 3 cannot rotate in a direction reverse to the given one, since the coupling elements 5 and 6 will engage with the rotation transmission element 7 and the input axle 2, forcing the rotation element 8 to rotate simultaneously in opposite direction, which leads to deadlock of the output axle 3. This is a positive feature in, for example, lifting devices since it does not allow the load to fall down. Bevel gears, or couples working on the force of friction, can be used in as rotation transmitting elements 7, 8, 9.

The claimed device for converting reciprocating rotary motion to unidirectional rotation movement may be used, for example, in lifting devices, electric power generators, machine-tools, pumps, and transport facilities.

This device can entirely replace the crank-and-rod mechanism used in engines, which results in dead points, and the applied force in which is directed to bend the axis of the crank axle rather than rotating, thereby significantly reducing the efficiency factor of a crank mechanism. The increase of power capacity, overall dimensions, and economical efficiency is achieved using the claimed device in internal combustion engines (FIG. 2), due to the application of force of the reciprocal motion of the piston tangential to the gear 10 mounted on the input axle 2 of the claimed device, thereby eliminating the upper dead point in the crank mechanism in which the pressure of the pushing gases is directed initially to bending the crank axle necks.

The advantages achieved with the use of the claimed technical solution are as follows:
a device is created that converts the rotation in any direction with an unlimited angle of rotation of the input axle into rotation of the output axle in one direction with the same angular velocity,
increase in performance efficiency of the device,
increase in functionalities.

### INDUSTRIAL UTILITY

The claimed invention can be used in lifting devices, electric power generation devices, machine-tools, pumps, transport facilities, particularly in internal-combustion engines.

1. A device for converting reciprocating rotary motion into rotation motion, comprising a body with input and output axles, characterized in that the device is provided with at least one intermediate axle installed in the body perpendicular to the input axle; at least two rotation transmitting coupling elements carried out as a free-wheel clutch or ratchet clutch rigidly mounted on the output axle with the possibility of mutually reverse rotational action; and at least three rotation transmitting elements interconnected among themselves and rigidly mounted between the coupling elements so as also be capable of mutually reverse rotation for transmitting the rotation of output axle in one direction.

2. The device of claim 1, characterized in that the rotation transmitting elements is rigidly mounted on the intermediate axle and two others are rigidly interconnected with coupling elements.

3. The device of claim 1, characterized in that the rotation transmission element is carried out as conical gear.

4. The device of claim 1, characterized in that the axles are used as the input, output and intermediate axles.
